(19) United States
(12) Patent Application Publication
(10) Pub. No.: US 2022/0121818 A1
(43) Pub. Date: Apr. 21, 2022

(54) DEPENDENCY GRAPH-BASED WORD EMBEDDINGS MODEL GENERATION AND UTILIZATION

(71) Applicant: DATA DRIVEN CONSULTING, INC., Miami, FL (US)

(72) Inventor: Deepak Gopalakrishnan, Kerala (IN)

(21) Appl. No.: 17/070,919

(22) Filed: Oct. 15, 2020

(51) Int. Cl. G06F 40/279; G06F 40/205; G06N 20/00; G06F 40/166; G06F 16/901; G06F 16/33; G06V 10/40; G06V 30/10

(52) U.S. Cl. CPC G06F 40/279; G06F 40/205; G06N 20/00; G06V 30/10; G06F 16/9024; G06F 16/3346; G06V 10/40; G06F 40/166

(57) ABSTRACT

A method for dependency graph-based word embeddings model generation includes the loading into memory of a computer of a corpus of text organized as a collection of sentences and the generation of a dependency tree for each word of each of the sentences. The method additionally includes the matrix factorization of each generated dependency tree so as to produce a corresponding word embedding for each word of each of the sentences without utilizing co-occurrence in order to create a word embeddings model. Finally, the method includes the storage of the model as a code book in the memory of the computer. The code book may then be used in producing a probability that a prospective term during textual analysis of a target document appears in the target document based upon a known presence of a different word in the target document and a relationship therebetween specified by the code book.

### BACKGROUND OF THE INVENTION

### Field of the Invention

The present invention relates to the field of text analysis and more particularly to dynamic position determination for text insertion in a document.

### Description of the Related Art

Text analysis refers to the digital processing of an electronic document in order to understand the context and meaning of the sentences included therein. Traditional text analysis begins with a parsing of the document to produce a discrete set of words. Thereafter, different techniques can be applied to the set of words in order to identify sentences or phrases and to ascertain a meaning of each of the sentences. Traditionally, parts-of-speech analysis and natural language processing (NLP) may be applied in the latter instance in order to determine potential meaning for each of the sentences. Finally, the determined for each of the sentences meaning may be composited into an overall document classification and characterization, such as indicating a nature or topic of the document and a specific notion in respect to the topic.

In the course of ascertaining a meaning of each sentence in a document, vector space representation techniques may be applied to the words in each sentence. To wit, recent methods for learning vector space representations of words have succeeded in capturing fine-grained semantic and syntactic regularities using the concept of “co-occurrences”. In co-occurrence, the presence of two different words in the same sentence repeatedly are noted so as to indicate the high probability that when one word is detected in a parsed sentence, the other word is likely to appear as well. Yet, in determining a meaning for a sentence, relying on co-occurrences of words does not always produce an optimal extraction of the relationship between those words. Rather, co-occurrence only suggests that the two words oftentimes appear together in a single sentence.

As an improvement over mere co-occurrence analysis, word embeddings provides a promising mechanism for extracting meaning from parsed text. In word embeddings, a distance between or angle between pairs of word vectors are relied upon as the primary method for evaluating the intrinsic quality of such a set of generated vectors. Similar words would exhibit minimal Euclidean distance and a cosine similarity closer to the value of one, whereas dissimilar word vectors exhibit high Euclidean distance and cosine similarity tending to the value of zero. The true semantic meaning of each text content can be represented as a feature vector. Word embeddings models have made solutions to problems such as speech recognition and machine translation much more accurate. Yet, in the context of text analysis, word embeddings have been ignored in favor of an analysis based upon mere co-occurrence.

### BRIEF SUMMARY OF THE INVENTION

Embodiments of the present invention address deficiencies of the art in respect to text analysis and provide a novel and non-obvious method, system and computer program product for dependency graph-based word embeddings model generation and utilization. In an embodiment of the invention, a method for dependency graph-based word embeddings model generation includes the loading into memory of a computer of a corpus of text organized as a collection of sentences and the generation of a dependency tree for each word of each of the sentences. The method additionally includes the matrix factorization of each generated dependency tree so as to produce a corresponding word embedding for each word of each of the sentences without utilizing co-occurrence in order to create a word embeddings model. Finally, the method includes the storage of the model as a code book in the memory of the computer. The code book may then be used in producing a probability that a prospective term during textual analysis of a target document appears in the target document based upon a known presence of a different word in the target document and a relationship therebetween specified by the code book.

In one aspect of the embodiment, the dependency tree is generated for each of the sentences in the corpus of text by parsing each one of the sentences into a parse tree, extracting from each parse tree, a from-vertex word, a to-vertex word and a relationship type between the from-vertex word and the to-vertex word, concatenating the to-vertex word and the relationship type together with a separation delimiter, and encoding each unique from-vertex word with a corresponding unique concatenation and a unique code. In another aspect of the embodiment, the word embeddings model is trained on a user to item ranking, the user being the encoded unique from-vertex word, the item being the encoded corresponding unique concatenation, and the ranking being the value “1”. In yet another aspect of the embodiment, the word embeddings model is hyperparameter optimized for convergence assurance.

In another embodiment of the invention, a textual analysis method utilizing a dependency graph-based word embeddings model includes loading into memory of a computer, both a target document subject to text analysis, and also a dependency graph-based word embedding model produced from matrix factorization, without co-occurrence, of a collection of dependency trees generated for each word of a set of sentences in a training corpus. A prospective term in the target document is then identified during the text analysis and submitted to the model. The model in turn produces a probability that the prospective term appears in the target document based upon a known presence of a different word in the target document and a relationship therebetween. Finally, the prospective term is inserted as a recognized term into the target document subject to the probability exceeding a threshold value.

In one aspect of the embodiment, the text analysis in an image processing of the target document into editable text. Alternatively, the text analysis in data extraction processing of an image of the target document into a database. As yet another alternative, the text analysis is a text to speech processing of an image of the target document into an audible signal.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for dependency graph-based word embeddings model generation and utilization;

FIG. 2 is a schematic illustration of a data processing system configured for dependency graph-based word embeddings model generation; and

FIG. 3 is a flow chart illustrating a process for dependency graph-based word embeddings model generation.

### DETAILED DESCRIPTION OF THE INVENTION

Embodiments of the invention provide for dependency graph-based word embeddings model generation and utilization. In accordance with an embodiment of the invention, a corpus of text organized as a collection of sentences is processed to generate a dependency tree for each word of each of the sentences. Then, each generated dependency tree is subjected to matrix factorization so as to produce a corresponding word embedding for each word of each of the sentences without utilizing co-occurrence. The result is a word embeddings model that may then be stored as a code book. The code book, in turn, may then be used in producing a probability that a prospective term during textual analysis of a target document appears in the target document based upon a known presence of a different word in the target document and a relationship therebetween specified by the code book.

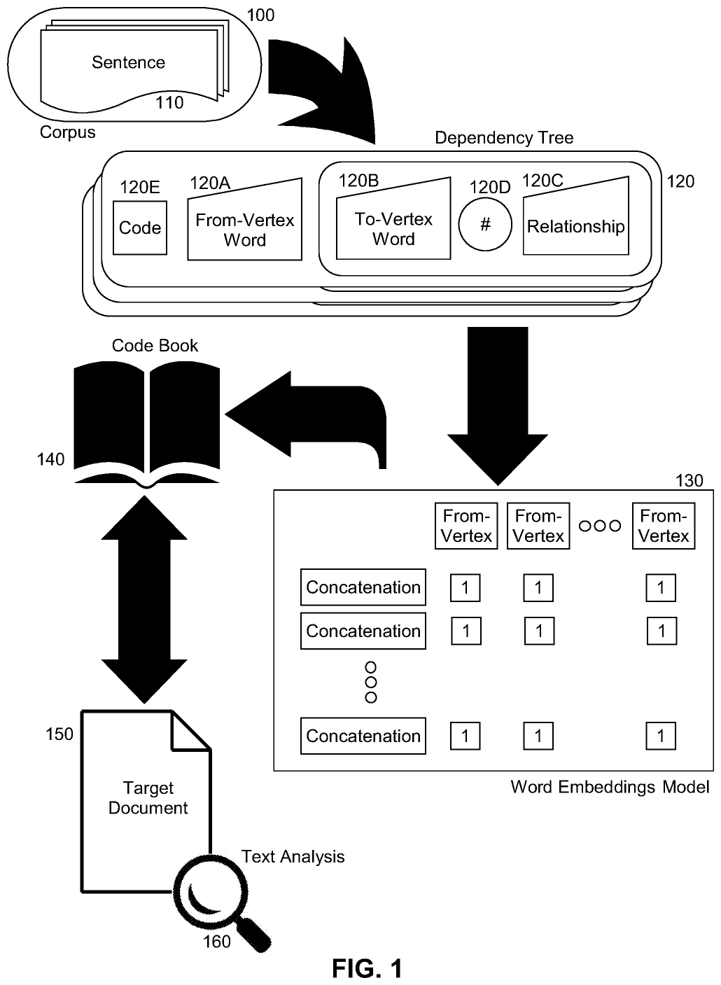

In further illustration, FIG. 1 pictorially shows a process for dependency graph-based word embeddings model generation and utilization. As shown in FIG. 1, a corpus 100 of different sentences 110 are used as training data to produce a word embeddings model 130. Specifically, a dependency tree 120 is produced for each of the sentences 110 by identifying through parts of speech analysis, a from-vertex word 120A—namely the noun subject, a to-vertex word 120B—namely the verb object and a relationship 120C therebetween—namely the verb. An encoding is then produced for the dependency tree 120 including the from-vertex word 120A and a concetanation of the to-vertex word 120B and the relationship 120C separated by a delimiter 120D. Finally, a unique code 120E such as a numerical counter is included in the encoding.

The dependency trees 120 as encoded are then subjected to matrix factorization. The matrix factorization is of type user-item-ranking. The user in this instance is the from-vertex word 120A of each of the encoded dependency trees 120. The item is the corresponding concatenation of the to-vertex word 120B and the relationship 120C separated by a delimiter 120D of each of the encoded dependency trees 120. Finally, the ranking begins with the numerical value of “1”. The resultant matrix is the word embeddings model 130. Optionally, the word embeddings model 130 may be optimized utilizing hyperparameter optimization. Finally, the optimized form of the word embeddings model 130 is stored as a code book 140 of vectors therein, each including a respective unique identifier, from-vertex word and concatenation.

The code book 140 may then be used in the course of a text analysis 160 of a target document 150, for instance the image processing of the target document 150 into editable text, the data extraction processing of an image of the target document 150 into a database or a text to speech processing of an image of the target document 150 into an audible signal. More particularly, a prospective term in the target document 150 that has been identified during the text analysis 160 is submitted to the code book 140. The code book 140 in turn produces a probability that the prospective term appears in the target document 150 based upon a known presence of a different word in the target document 150 and a relationship therebetween. Finally, the prospective term is inserted as a recognized term into the target document 150 subject to the probability exceeding a threshold value.

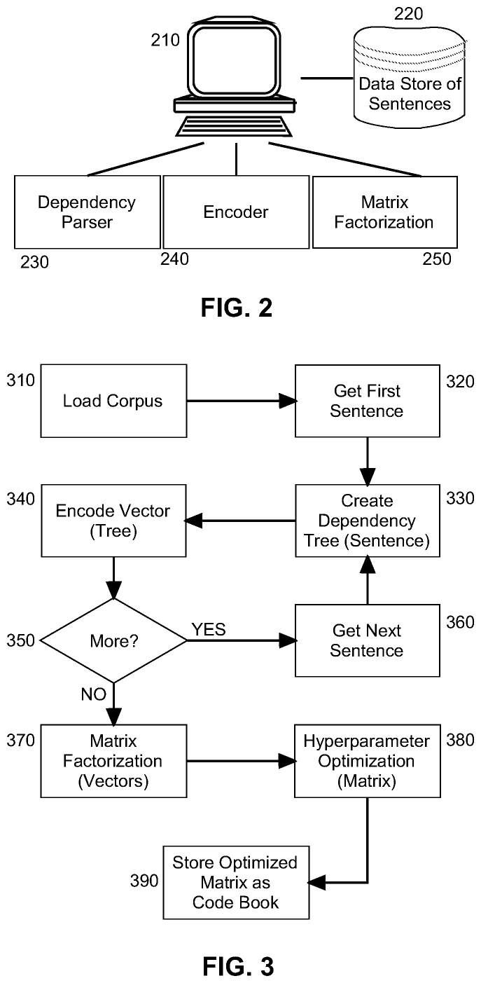

The process described in connection with FIG. 1 may be implemented within a data processing system. In further illustration, FIG. 2 schematically shows a data processing system configured for dependency graph-based word embeddings model generation. The system includes a host computing platform 210 that includes one or more computers, each with memory and at least one processor. A data store 220 is coupled to the host computing platform 210 and stores therein a corpus of sentences for use as training data in training a word embeddings model. Three different programmatic modules operate in the memory of the host computing platform 210: a dependency parser 230, an encoder 240 and a matrix factorization module 250.

The dependency parser 230 includes computer program instructions operable during execution in the host computing platform 210 to parse the sentences in the data store 220 to build for each of the sentences, a dependency tree relating the noun subject of a corresponding sentence to a verb object by way of a verb relationship. The encoder 240, in turn, includes computer program instructions operable during execution in the host computing platform 210 to encode each dependency tree as a vector relating the noun subject to a concatenation of a verb and verb object for the noun subject along with a unique identifier. Finally, the matrix factorization module 250 includes computer program instructions operable during execution in the host computing platform 210 to generate a word embeddings model in the memory of the host computing platform 210 by populating a matrix of noun subjects to corresponding concatenations with each combination having an assigned ranking. The program code of the matrix factorization module 250 further is enabled during execution to optimize the matrix and to persist the matrix as a code book.

In even yet further illustration of the operation of the data processing system of FIG. 2, FIG. 3 is a flow chart illustrating a process for dependency graph-based word embeddings model generation. Beginning in block 310, a corpus of sentences is loaded into memory of a computer and in block 320, a first sentence is retrieved for processing and in block 330, subsequent to NLP to as to identify the syntactic structure of the sentence, a dependency tree is created for the retrieved sentence indicating a noun subject of the sentence (the from-vertex word), a verb (relationship) and an object of the verb (to-vector word). In block 340 the dependency tree is then encoded into a vector with a unique identifier, an indication of a noun-subject of the dependency tree and a concatenation of a verb and verb object separated by a delimiter. In decision block 350, it is determined if additional sentences remain to be processed in the corpus. If so, a next sentence in the corpus is retrieved and the process repeats through block 330.

In decision block 350, when no further sentences remain to be processed in the corpus, in block 370 the vectors are subjected to matrix factorization in order to produce a user-item-ranking matrix relating each noun subject and corresponding concatenation with a ranking, initially the value of “1”. Then, in block 380, the matrix is optimized according to hyperparameter optimization. Finally, in block 390, the optimized matrix is stored as a code book for use in predicting patterns of words in a target document without reliance on a word co-occurrence model subject to excessive false positives.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A textual analysis method utilizing a dependency graph-based word embeddings model, the method comprising:
loading into memory of a computer, both a target document subject to text analysis, and also a dependency graph-based word embedding model produced from matrix factorization, without co-occurrence, of a collection of dependency trees generated for each word of a set of sentences in a training corpus;
identifying a prospective term in the target document during the text analysis;
submitting the prospective term to the model, the model producing a probability that the prospective term appears in the target document based upon a known presence of a different word in the target document and a relationship therebetween; and,
inserting the prospective term as a recognized term into the target document subject to the probability exceeding a threshold value.

2. The method of claim 1, wherein the text analysis in an image processing of the target document into editable text.

3. The method of claim 1, wherein the text analysis in data extraction processing of an image of the target document into a database.

4. The method of claim 1, wherein the text analysis is a text to speech processing of an image of the target document into an audible signal.

5. A method for dependency graph-based word embeddings model generation, the method comprising:
loading into memory of a computer, a corpus of text organized as a collection of sentences;
generating a dependency tree for each word of each of the sentences;
matrix factorizing each generated dependency tree to produce a corresponding word embedding for each word of each of the sentences without utilizing co-occurrence in order to create a word embeddings model; and,
storing the model as a code book in the memory of the computer.

6. The method of claim 5, wherein the dependency tree is generated for each of the sentences in the corpus of text by:
parsing each one of the sentences into a parse tree;
extracting from each parse tree, a from-vertex word, a to-vertex word and a relationship type between the from-vertex word and the to-vertex word, concatenating the to-vertex word and the relationship type together with a separation delimiter, and encoding each unique from-vertex word with a corresponding unique concatenation and a unique code.

7. The method of claim 6, wherein the word embeddings model is trained on a user to item ranking, the user comprising the encoded unique from-vertex word, the item comprising the encoded corresponding unique concatenation, and the ranking comprising the value “1”.

8. The method of claim 7, wherein the word embeddings model is hyperparameter optimized for convergence assurance.

9. The method of claim 5, further comprising utilizing the code book in producing a probability that a prospective term during textual analysis of a target document appears in the target document based upon a known presence of a different word in the target document and a relationship therebetween specified by the code book.

10. A computer program product for dependency graph-based word embeddings model generation, the computer program product including a computer readable storage medium having program instructions embodied therewith, the program instructions executable by a device to cause the device to perform a method including:
loading into memory of a computer, a corpus of text organized as a collection of sentences;
generating a dependency tree for each word of each of the sentences;
matrix factorizing each generated dependency tree to produce a corresponding word embedding for each word of each of the sentences without utilizing co-occurrence in order to create a word embeddings model; and,
storing the model as a code book in the memory of the computer.

11. The computer program product of claim 10, wherein the dependency tree is generated for each of the sentences in the corpus of text by:
parsing each one of the sentences into a parse tree;
extracting from each parse tree, a from-vertex word, a to-vertex word and a relationship type between the from-vertex word and the to-vertex word, concatenating the to-vertex word and the relationship type together with a separation delimiter, and encoding each unique from-vertex word with a corresponding unique concatenation and a unique code.

12. The computer program product of claim 11, wherein the word embeddings model is trained on a user to item ranking, the user comprising the encoded unique from-vertex word, the item comprising the encoded corresponding unique concatenation, and the ranking comprising the value “1”.

13. The computer program product of claim 12, wherein the word embeddings model is hyperparameter optimized for convergence assurance.

14. The computer program product of claim 10, wherein the method further includes utilizing the code book in producing a probability that a prospective term during textual analysis of a target document appears in the target document based upon a known presence of a different word in the target document and a relationship therebetween specified by the code book.
